(19) United States
(12) Patent Application Publication
(10) Pub. No.: US 2025/0199669 A1
(43) Pub. Date: Jun. 19, 2025

(54) Dynamic Graphical Interface for Intuitive A.I. Prompting

(71) Applicants: Mohamed Azeez, Astoria, NY (US); Chaewon Park, Santa Clara, CA (US)

(72) Inventors: Mohamed Azeez, Astoria, NY (US); Chaewon Park, Santa Clara, CA (US)

(21) Appl. No.: 18/544,891

(22) Filed: Dec. 19, 2023

(51) Int. Cl. G06F 3/04845; G06F 3/01; G06F 3/04815; G06F 3/0482; G06F 3/0486; G06F 3/0487; G06F 40/279; G06T 11/00

(52) U.S. Cl. CPC G06F 3/04845; G06F 3/017; G06F 3/0486; G06F 3/0487; G06F 40/279; G06T 11/00; G06F 3/04815; G06F 3/0482; G06T 2200/24

(57) ABSTRACT

Disclosed is a dynamic and visually-driven interface that revolutionizes AI-based content creation. This interface leverages graphical tools, enabling users to intuitively prompt a generative AI model. Instead of relying solely on text-based prompts, users employ a combination of drag-to-prompt, file imports, tap-for-value, dial-for-value, and other visually intuitive tools. The system offers capabilities like long-form prompting, adaptive prompting, augmented reality integration, and collaborative prompting. One standout feature is the flexibility of inserting, replacing, or dragging blocks from different conversation chains, allowing users to influence content direction. This facilitates a non-linear approach to AI content creation, offering more control over outputs. Enhancements also include a fact-checking module and stylistic filters, elevating content accuracy and appropriateness.

### FIELD OF INVENTION

The invention pertains generally to the field of generative Artificial Intelligence and more particularly to dragging blocks of a prompt-response chain into another to generate a prompt. (Hereinafter referred to as Drag-to-Prompt).

### BACKGROUND OF INVENTION

The recent advent of machine learning and generative AI has revolutionized society across multiple domains. These technologies, such as ChatGPT and Bard, have significantly impacted content creation, both in short-form and long-form formats. By leveraging advanced machine learning algorithms, generative AI systems can generate content based on provided prompts. However, a major limitation of current generative AI interfaces lies in their exclusive reliance on text-based input modalities. Users are restricted to providing prompts in textual form, limiting their ability to interact with the system in more diverse and intuitive ways. This reliance on text-based input leads to suboptimal response outcomes and stifles productivity and creativity. Chaining, a critical aspect of long-form content creation, becomes cumbersome due to the text-based modality. The linear nature of prompt-response chains hampers the smooth flow of ideas and content, hindering the creative process. As a result, users face challenges in effectively constructing coherent and engaging long-form content.

However, this text-based modality has its limitations. It restricts users from harnessing the full potential of visual or graphical modalities, which can provide more intuitive and expressive means of communication. Traditional generative AI interfaces lack the incorporation of visual or graphical elements, preventing users from utilizing these powerful modes of interaction. The absence of visual or graphical modalities in generative AI interfaces can be attributed to the challenges associated with incorporating and interpreting visual or graphical data. While significant advancements have been made in computer vision and graphical processing, integrating these capabilities into generative AI systems is a complex task. The models used in generative AI are predominantly trained on textual data and lack the ability to effectively process and generate content based on visual or graphical prompts.

Currently, the state of the art in generative AI lacks a crucial element: a visual graph for prompt commanding and prompt-response chain construction. This absence creates a void in the current capabilities of generative AI systems. While generative AI has made significant progress in various domains, the absence of a visual graph hampers the ability to interact with and shape the generated content in a more intuitive and dynamic manner. The linear nature of prompt-response chains restricts creative exploration and control, limiting users' ability to freely mix and match prompts and responses within the chain.

To overcome these limitations, there is a pressing need for alternative and more expressive modes of interaction with generative AI systems. By introducing additional modalities, such as visual or graphical inputs, users would gain the ability to communicate their ideas and preferences in a more natural and intuitive manner. This would facilitate a more seamless and dynamic content creation process, fostering greater productivity and unleashing creative potential.

A dynamic visual or graphical prompting interface would fill this void by providing users with a graphical representation of the prompt-response chain. This visual representation would allow users to strategically insert edits at any point within the chain, introduce new prompts or responses, and borrow from alternative chains or unrelated sources. The visual graph would serve as a canvas for users to navigate and manipulate the content trajectory and the prompt-response journey according to their preferences and needs.

By incorporating a visual graph, users would gain a comprehensive overview of the prompt-response chain, enabling them to easily identify connections, patterns, and potential areas for modification. This enhanced level of interaction and visualization would facilitate a more intuitive and flexible approach to constructing prompt-response chains.

Furthermore, the visual graph would offer a powerful tool for both short-form and long-form outputs. Whether it's creating concise itineraries or detailed scripts, the visual representation would provide a visual command center for users to orchestrate and customize the generated content.

Let's address the limitations of static A.I. interfaces, such as ChatGPT or Bard, through a cautionary tale. ChatGPT and Bard fall short in providing advanced content creation capabilities, particularly for researchers like Dr. Jerry Scalici, the Chair of Neuroscience at Farragut University School of Medicine, who is preparing his peer review article on drosophila circadian circuitry for submission to the renowned journal, Nature. When using text-based A.I. interfaces like ChatGPT, Dr. Scalici faced several constraints. Visual elements and graphical interactions were absent, hindering his ability to curate and chain complex concepts across a maze of prompt and response generative A.I. blocks. He lacked advanced controls, making it challenging to emphasize the significance of specific research findings within his content. Chain clean-up was virtually impossible, leaving his responses cluttered and disorganized. Collaboration with his research team was restricted, as the interface did not support real-time interaction or content sharing. Moreover, the absence of predictive and adaptive prompting features limited Dr. Scalici's ability to generate precise and compelling generative A.I. copy for his article. The inability to drag blocks within the interface across chains or reassign weights and values hindered his creative flow and efficiency. Dr. Scalici's inability to break away from static A.I. led to a missed deadline, potentially derailing him from his tenure track.

In conclusion, the current state of the art in generative AI lacks a visual graph for prompt commanding and prompt-response chaining. Integrating a visual graph into the system would fill this void, empowering users to navigate and shape the content trajectory or prompt-response journey behind generative content creation in a more intuitive and dynamic manner. This advancement in graph prompting using a dynamic graphical interface for intuitive A.I. prompting would greatly enhance the interaction and customization capabilities of generative AI, benefiting both short-form and long-form outputs.

While generative AI has made remarkable advancements in content creation, the predominant text-based modality of input poses limitations in terms of response outcomes, productivity, and creativity. Expanding the interaction modalities to include visual and graphical inputs would enable a more diverse and expressive engagement with generative AI systems, fostering enhanced content creation experiences across various formats. There is a void in the market for a dynamic graphical interface for an A.I. model (integrated natively or hooked on to a 3^{rd}-part A.I. model as an API/plug-in) that enables intuitive A.I. prompting-allowing users to break away from static A.I.

### SUMMARY

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions. The following exemplary aspects all reside in enabling a user to prompt a generative AI model using graphical or visual tools to define, refine a prompt, rather than, or in addition to text-based prompts. Controls of the graphical elements to intuitively prompt may be at least one of a click, mouse, touch, gestured (hand, eye, and/or body), voice, or mind-controlled.

The present invention discloses a novel and innovative dynamic graphical interface designed to enhance the intuitive nature of AI prompting. The interface comprises a user-friendly platform that enables users to provide prompts to the AI system in a manner that goes beyond traditional text-based commands. An A.I. interface configured for intuitive prompting, Graphi-Prompt addresses the limitations of static A.I. models head-on, revolutionizing the way we interact with A.I. for content creation.

Graphi-Prompt is an A.I. Interface configured with a variety of graphical interface tools, such as drag-to-prompt, file import, tap-for-value, dial-for-value, tap-for-training, insta-prompting by dragging or tapping pre-defined icons from a custom library; pin-point prompting, which defines a prompt command based on the pin-point location of the dragged block or icon, social media/publishing gateways, predictive and adaptive prompting, etc., for a more intuitive prompting and chaining experience. The tools may be employed to enable the following key features: long-form prompting/chaining (script, for instance); short-form prompting (resume, itinerary, etc.); Extracting key features for graphical element generation; natively embedding graphical elements in a prompt; A.R. integration; multi-modal inputs; predictive prompting; adaptive prompting; collaborative prompting; graphical element library/visual language or protocol, contextual awareness; and a prompt guidance. Six graphical tools across 10 key intuitive prompting features Tradename: (Graphi-Prompt □). Verb: (Intuitive Prompting/Graph Prompting □).

Enter the visual realm of A.I. content creation with Graphi-Prompt, where the power of graphics meets A.I. to unlock creativity. Meet Dr. Jerry Scalici, head of neuroscience at Farragut, as he harnesses the extraordinary visual and graphical capabilities of Graphi-Prompt to elevate his research article for Nature. Gone are the static confines of traditional A.I. With Graphi-Prompt's dynamic graphical interface, Dr. Scalici effortlessly organizes his research into draggable, visually engaging blocks. Response blocks emerge as captivating copy, curated with artistic precision, captivating readers with every word.

Through intuitive gestures, Dr. Scalici taps certain blocks, adding prompt value and fine-tuning his narrative. Graphical dials appear as pop-ups, enabling him to adjust prompt values for essential features identified in the initial prompt, ensuring his content takes center stage. Chain clean-up transforms the construction process, weaving together a seamless and impactful flow in his content. The predictive prompt tools inspire real-time suggestions based on Dr. Scalici's history. optimizing his research efficiency and propelling his ideas forward. Collaborative prompting unites Dr. Scalici with his Hillside University colleague, sparking a creative fusion of ideas. Together, they co-prompt and co-chain, uncovering groundbreaking insights and pushing the boundaries of knowledge.

In the journey from static to intuitive, Dr. Scalici's brilliance shines. Graphi-Prompt empowers him to meet Nature's deadlines and editorial standards, solidifying his status as the foremost circadian circuitry expert in the country. Embrace the visual and graphical revolution with Graphi-Prompt. Explore its transformative power, from education to business and creativity, as you unlock the full potential of A.I. interactions. Step into the future of A.I. content creation, where visuals reign supreme, and static limitations fade away. Discover Graphi-Prompt: A first-of-its-kind, visually-driven interface, shaping the future of A.I. prompting.

In one aspect, the solution seeks to enable a non-linear approach to generative AI, where users can freely insert edits at any point along the prompt-response chain. This flexibility allows for the intentional differentiation and pivoting of content evolution, offering users greater control over the generated outputs and fostering more creative exploration and customization.

In one exemplary aspect, the system is capable of generating prompts based on insertion of a block into a prompt-response chain (PRC). The initial prompt provides the AI with a context or direction in which to generate responses. For example, if the initial prompt was about writing a suspenseful short story the AI would generate a response in line with this direction. After generating an initial response, the user may wish to provide an additional prompt or insert a block from another chain. This can be seen as a form prompt generation, where each inserted block serves as a prompt to further the user's request.

The intriguing aspect of this concept is the ability to drag and drop blocks of other conversation chains to generate new prompts and differentiate conversation chains. For example, if the initial prompt was the start of a story, the AI might generate one chain where the story takes a sci-fi direction, another where it becomes a mystery, and yet another where it turns into a romance. One of the most interesting features of this concept is the ability to insert and/or replace prompt and response blocks in the chain at any point. This allows for a high degree of flexibility and customization. Users can alter the direction of any chain by replacing a prompt or response, effectively changing the path that the chain takes. For example, if a user didn't like the sci-fi direction of the story, they could replace the prompt or response that led to it, causing the AI to generate a new prompt and lead the chain down a romantic-comedy path-yet still being consistent with existing characters, character arch, plot line, etc., associated with that same chain-effectively enabling turn-table style content generation and differentiation. This can also apply to shorter form requests from a user, such as an itinerary or a resume. In such an example, blocks from other chains or outside information can be inserted into the initial user prompt to change the outcome, without the need for an additional typed prompt and regeneration.

The concept involves compiling across chains to synthesize a final product or goal or choose a fully differentiated chain as the final product. This gives users the ability to compare and contrast different chains, choosing the one they like best or combining elements from different chains to create a hybrid. For example, a user might like the plot of the sci-fi story, the characters of the mystery, and the setting of the romance, and choose to combine these elements into a final product. It is yet another object of the invention to enable a user to easily ensure their final product is cohesive. What's more, a chain can be manipulated to remove all prompts in order for the generated content to be ready for export.

This concept represents a dynamic and flexible approach to AI-assisted content generation, allowing users to guide the process and make changes as they see fit. This could be particularly useful in fields like content generation-spanning across visual, audio, and written medium. It could also be a powerful tool in product development and brainstorming ideas, such as inventive embodiments, or really any task or goal that involves iterative idea development and refinement.

In the present embodiment further discussed in this application, cursor controls can be used to graphically generate a prompt. In other embodiments there may be integration of Augmented Reality (AR), where AR technology is used to enhance the graphical prompting and chaining experience. This could involve overlaying graphical elements onto the user's real-world environment, providing a more immersive and interactive interface. There may also be multi-modal input wherein voice commands or touch gestures may be used in addition to graphical controls. This allows users to interact with the system using their preferred input method, providing a more flexible and inclusive user experience. In an embodiment, the generative AI may have auto-prompt suggestions where the AI analyzes user input and provides contextually relevant suggestions for the next prompt. This feature can leverage machine learning techniques to understand user preferences and generate prompt recommendations tailored to their needs.

In an embodiment, the AI system may allow for collaborative prompting and chaining. This can enable collaborative capabilities within the interface, allowing multiple users to contribute and collaborate on the prompt generation and chaining process. This can be particularly useful for teamwork, brainstorming sessions, or educational purposes. An embodiment may also include enhanced visualization tools like zooming in or out visual to assist users in understanding and manipulating the prompt and response chains effectively. Embodiments may also include an expanded graphical element library to provide users with a comprehensive range of graphical elements to enhance the visual prompting and chaining process. In an embodiment, the AI system may also be able to contextually generate prompts, wherein a context-aware prompt generation mechanism that takes into account the ongoing conversation, user history, or external factors to generate prompts that are more relevant and meaningful in the given context. In an embodiment, the AI system may provide annotations, that can be controlled by the user or AI to provide a simplistic explanation of the blocks in a prompt-response chain. In further embodiments, the AI system may also include an option to share chain to a number of social media applications and thus provide a simple means of sharing their created content.

### Graphi-Prompt Interactive Tools:

1. Drag-to-prompt
2. Tap-for-value
3. Block flagging
4. Chain clean up
5. Pin-dropping
6. File import
7. Graphical command dragging
8. Dial-for-value

### Graphi-Prompt Prompt Features/Functionalities:

1. Long form content prompting (script, etc.)
2. Short form content prompting (resume, travel itinerary, etc.)
3. Predictive prompting
4. Adaptive or contextualized prompting
5. Chain clean up
6. Social media/sharing/publishing
7. Collaborative or group prompting
8. Graphical element library
9. Customized or factory-setting pop-up or fixed “icon” bar (graphical elements or actionable
visuals appearing alone or grouped).
10. Prompt guidance
11. AR integration
12. Tap-for-Training/Reinforcement
13. Block annotation (summary of blocks/role to overall chain)
14. Render files into actionable PRC blocks

Graphi-Prompt continues to revolutionize AI interactions, integrating rigorous fact-checking, stylistic versatility, and user feedback loops to ensure content is not only intuitive but also accurate, styled, and contextually apt. The fusion of factual rigor, stylistic flair, and the existing dynamic graphical interface marks Graphi-Prompt as the future benchmark in AI content creation. To complement the existing dynamic and intuitive graphical interface known as Graphi-Prompt, further enhancements are integrated to ensure the accuracy and appropriateness of the AI-generated content. One core feature involves a feedback loop wherein the user flags any instances of data “hallucination” from the AI's responses. This information is pivotal in updating the model's reward system. Recognizing the fast-evolving nature of information, the AI system undergoes periodic training on recent web articles and documents, mitigating issues arising from outdated or limited datasets.

A salient feature introduced is the Fact-Checking Module, where users can set a veracity threshold tailored to the application context. For example, while drafting a fictional novel may require a low fact-checking threshold, situations demanding factual rigor can raise this threshold closer to 1. The module cross-references AI responses against a curated set of reliable sources, such as news websites and official portals. If a generated response falls below the set threshold, the AI can either signal uncertainty or seek more specific input from the user.

In addition to these mechanisms ensuring factual accuracy, the system boasts an adaptable style filter. A user can dictate the narrative tone or style, such as rewriting content “in the style of a New Yorker article”. The AI system can further provide style suggestions based on the text's genre. Thus, the essence of a prompt can be maintained while altering its stylistic delivery.

Additionally, the proposed veracity threshold plays a double role in performance and accuracy. When a low threshold is set, the system can cross-reference against a smaller dataset, hastening the response time. Conversely, a high threshold mandates a rigorous check against a broad spectrum of trusted sources, necessitating slightly more time but ensuring a more grounded response. Visual elements further enhance user experience. An innovative “Style Dial” or “Style Bar” allows for easy style adjustments, while a veracity dial lets users modulate the level of fact-checking required. These dials not only offer a consistent and intuitive UI/UX but can also be integrated into the system's reward/reinforcement loop.

Other embodiments of this aspect include corresponding computer systems, apparatus, and computer programs recorded on one or more computer storage devices, each configured to perform the actions of the methods. Other aspects and advantages will be described in the following detailed description of the figures.

### BRIEF DESCRIPTION OF FIGURES

FIG. 1A depicts a network view of the system in accordance with an aspect of the invention.

FIG. 1B depicts a close-up view of the system in accordance with an aspect of the invention.

FIG. 2 depicts a method flow diagram in accordance with an aspect of the invention.

FIG. 3 depicts a mockup of an exemplary user interface of the apparatus in accordance with an aspect of the invention.

FIG. 4A depicts a close-up view of the system in accordance with an aspect of the invention.

FIG. 4B depicts a close-up view of the system in accordance with an aspect of the invention.

FIG. 5A depicts a close-up view of the system in accordance with an aspect of the invention.

FIG. 5B depicts a close-up view of the system in accordance with an aspect of the invention.

FIG. 6A depicts a close-up view of the system in accordance with an aspect of the invention.

FIG. 6B depicts a close-up view of the system in accordance with an aspect of the invention.

FIG. 7 depicts a close-up view of the system in accordance with an aspect of the invention.

### DETAILED DESCRIPTION

Numerous embodiments of the invention will now be described in detail with reference to the accompanying figures. The following description of the embodiments of the invention is not intended to limit the invention to these embodiments but rather to enable a person skilled in the art to make and use this invention. Variations, configurations, implementations, and applications described herein are optional and not exclusive to the variations, configurations, implementations, and applications they describe. The invention described herein can include any and all permutations of these variations, configurations, implementations, and applications.

In the following description, numerous specific details are set forth in order to provide a thorough understanding of the invention. It will be apparent, however, to one skilled in the art that the invention can be practiced without these specific details.

Reference in this specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but no other embodiments.

In an embodiment this invention is a system to prompt a generative AI model without text. The system comprises of a user interface configured to receive at least an initial user prompt comprising of at least one instruction defining a command, wherein the input defining the command is not text based. The system is composed of tools to tailor the response from the generative AI, such as: drag and drop, pinpoint drop, tap for value, and an intensity dial.

In other embodiments, dragging may not be required, especially for short-form content generation such as an itinerary or resume. As a prompt-response chain requires at least one prompt and response, no additional blocks may need to be added. Instead, the response can be altered by at least the intensity dial to prompt the AI to include more information about specific aspects of the short-form content.

### Glossary

a. User directed differentiation: introducing and/or replacing at least one of a prompt or response from within the chain or from at least the second chain
b. Differentiation: altering a stylistic and/or thematic element of the first chain based on the import from the at least second chain and insertion point in chain 1
c. Prompt and response chain: consists of at least one prompt and response in a conversation with the AI
d. First response: generated relating to the stylistic and/or thematic elements requested in the prompt
e. Initial user prompt: consists of a text-based input with instructions related to creative content generation with a stylistic and/or thematic element
f. Block: refers to any individual prompt or response in a prompt-response chain
g. Stylistic and thematic elements: stylistic and thematic elements are the manner in which the response is written, for example in the style of Jane Austen. Thematic elements consider common themes in writing such as horror or romance.
h. Drag and drop: the manner in which a prompt/response is inserted/replaced in the chain, for example using a mouse, a user would hover over the selected block, left click, and then drag it over to another chain where they would like to insert it.
i. Chain clean up: all prompts except for the initial prompt are removed from the chain to create a cohesive response.
j. Block Checking: the user removes blocks that are not deemed acceptable.
k. Pinpoint drop: configuring different prompt commands based on the location of the drop.
l. Tap for value: number of taps on a block increases its value, resulting in a greater impact on the prompt response chain.
m. Intensity dial: the user can highlight key words in a block and turn the dial clockwise or counterclockwise to either heighten or diminish certain aspects in a response

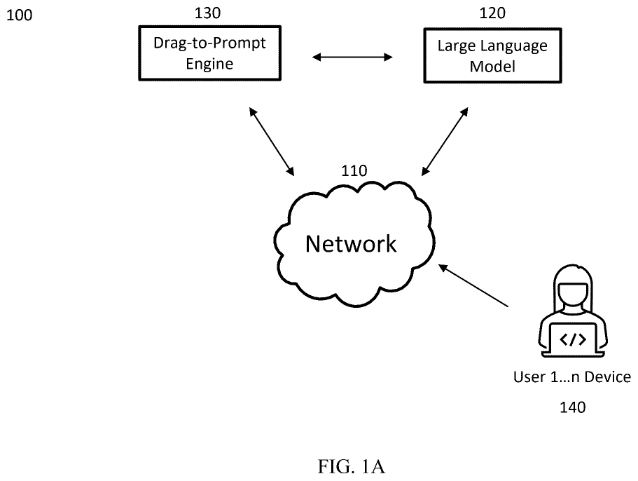

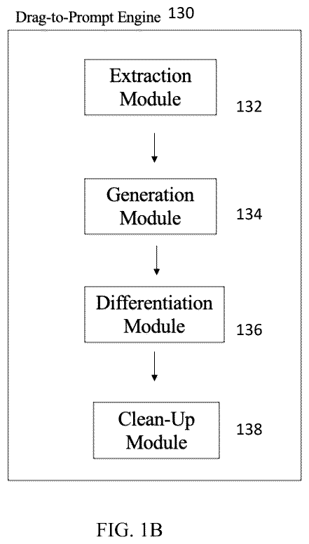

FIG. 1A depicts a system diagram in accordance with an aspect of the invention. FIG. 1 depicts a schematic of a system 100 for receiving, contextualizing, referencing, and producing content for a drag-to-prompt engine (DTP). In one embodiment, a system 100 can include: a network 110, a large language model 120, a drag-to-prompt engine 130 and an electronic computing device, such as a user 1 device 140 (mobile device, tablet, and laptop etc.). The large language model 120, drag-to-prompt engine 130, and the device 140 are communicatively coupled via a communication network 110. The network may be any class of wired or wireless network including any software, hardware, or computer applications that can provide a medium to exchange signals or data. The network may be a local, regional, or global communication network.

FIG. 1B further details components that comprise the DTP engine: an extraction module 132; a generation module 134, differentiation module 136; and a clean-up module 138. The DTP engine 130 may communicate with the large language model (FIG. 1A, 120) to receive text or drag and dropped based input from a user device and contextualize the instructions of the input to produce a response.

The identifying module is a crucial component within an AI system that is designed to identify response drivers from a text-based prompt provided by a user to an AI model. Its purpose is to analyze the prompt and determine which elements within it hold significant influence in defining the model's response. These influential elements, known as response drivers, are identified based on a threshold-grade command value assigned to them. The module examines the prompt and identifies any element that meets this threshold, indicating its importance in shaping the model's response. By effectively identifying response drivers, the module enables the AI system to prioritize and focus on the key elements within the user's prompt, ensuring that the generated response aligns with the user's intentions and expectations.

The generating module is a vital component within an AI system that is responsible for generating a graphical element, specifically designed to facilitate user interaction and regeneration of the AI model's response. This graphical element serves as an intuitive interface, allowing the user to adjust the command value of any key response driver and regenerate the response as a second prompt. The module takes into account the identified response drivers and their corresponding command values and incorporates them into the graphical element. Through this interface, the user can easily modify the influence of a specific response driver by adjusting its command value, thereby fine-tuning and customizing the AI model's response. The generating module ensures that the graphical element is user-friendly, visually appealing, and provides a seamless experience for users to interact with and regenerate the AI model's response according to their preferences and requirements.

In one embodiment of the drag and drop module 132, a pop-up window may be displayed to provide the user options as to how much of a prompt-response chain may be differentiated. Said options include, but are not limited to, regeneration of the entire chain, regeneration of preselected blocks, and regeneration of the inserted block. The drag and drop module 132 may further comprise of the option to control the intensity of the differentiation may by a dial displayed on a user interface to heighten or diminish the impact of an inserted and/or replaced block. The differentiation module 134, in an embodiment may differentiate the entirety of the prompt-response chain in response to user input via the drag and drop module. In other embodiments, all blocks upstream of the insertion point, all blocks downstream of the insertion point, or pre-selected blocks may be differentiated. The clean-up module 136 may be used to maintain consistency within the text of the chain in an embodiment. In other embodiments the clean-up module 136 may be further configured to extract and remove all prompts, retain the initial prompt in order to create a cohesive response, or allow the user to remove blocks deemed unacceptable by the user by block checking.

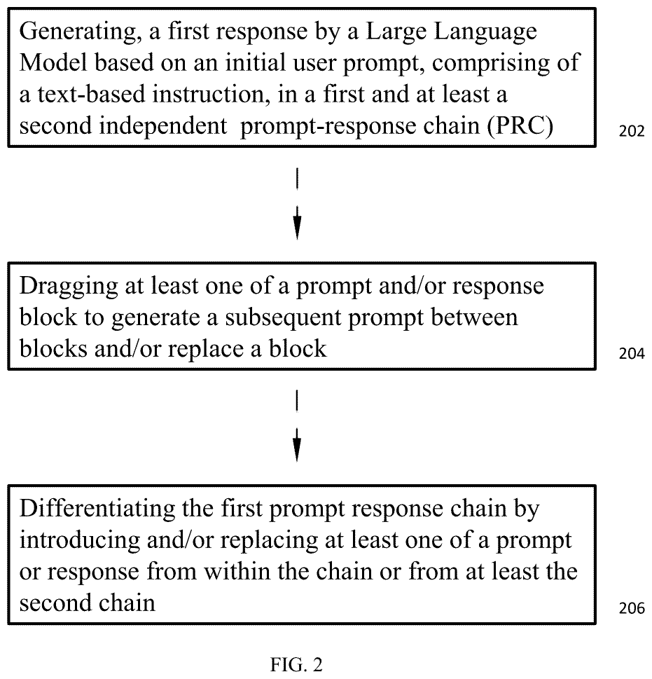

FIG. 2 depicts a method flow diagram in accordance with an aspect of the invention. As shown in FIG. 2, the method details the steps of: generating, a first response by a large language model based on an initial user prompt, comprising of a text-based instruction, in a first and at least a second independent prompt-response chain 202; dragging at least one of a prompt and/or response block to generate a subsequent prompt between blocks and/or replace a block, wherein the dragging occurs by a drag and drop in at least one form of a mouse cursor, vocalized request, hand gesture, or touch control 204; and differentiating the first prompt response chain by introducing and/or replacing at least one of a prompt or response from within the chain or from at least the second chain 206.

In an embodiment the prompt-response chain or finalized content may be saved on the user's device or shared to other digital spaces through the network. Such spaces include, but are not limited to, social media networks and other word processors.

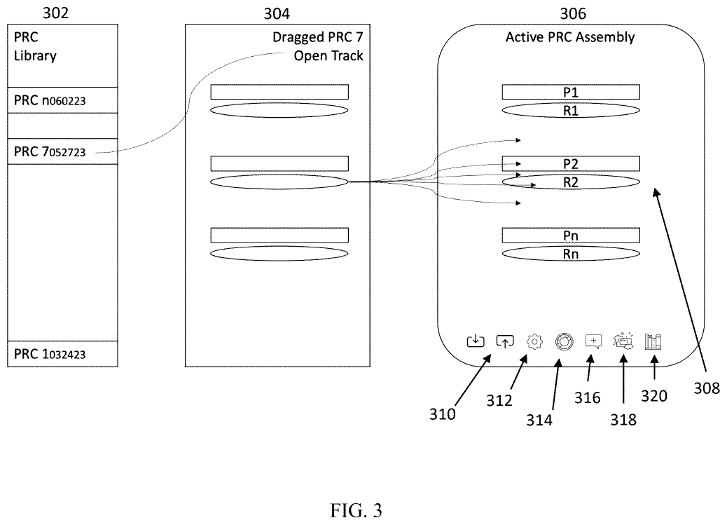

FIG. 3 depicts a mockup of an exemplary user interface of the apparatus in accordance with an aspect of the invention. The user interface comprises of a PRC Library 302, an open PRC track 304, and an active PRC assembly 306. The PRC assembly 306 further comprises of prompts and responses 308, as well as an upload/download function 310, a settings function 312, an intensity control dial 314, an annotation tool 316, a clean-up tool 318, and a graphical element library 320.

In an embodiment a PRC library 302 may consist of many PRCs that have been previously made by the user. Such PRCs may then be displayed on the user face in a collapsed form to allow for easy access as well as an open form for the user to select particular blocks to be dragged into an active PRC assembly. In an embodiment an active PRC assembly 306 allows the user to drag in blocks from other chains or import text, photos, videos, etc. In an embodiment, the user may complete a pinpoint drop, wherein a block may be inserted into a prompt or response, before or after a prompt or response, or to either side of a prompt or response. This results in the creation of a prompt with different prompt commands based on its inserted location without the need for a user to provide a generative AI with specific instructions.

In another embodiment, blocks may be tapped for value by the user. In said embodiment, the user may tap a block in a PRC, the number of taps by the user corresponds to the value of the block in the chain and its impact on the chain. In an embodiment, a user may highlight key words or phrases and then turn the dial icon to shift the impact of said words and phrases in the story. For example, if the romance aspect of a prompt for a story is highlighted, a user may turn the dial to have the romance play either a heightened or diminished role in the story. By tapping for value, the Large Language Model is trained to register certain blocks as containing preferred content by the user.

In other embodiments, the annotation tool 316 and/or graphical element library 320 may be utilized in the construction of a PRC. The graphical element library provides the user with additional shapes, icons, symbols, or visual representations that users can choose from to represent prompts, responses, relationships, or other elements within the system. This allows for further customization of the PRC. Additionally, the annotation tool can assist the user in categorizing blocks in a PRC. Through this a user can further determine what changes they wish to make to a PRC, perhaps in terms of the contents of the blocks or organization of them.

In an embodiment, the clean-up tool 318 assists the user in creating a final format for their PRC. As previously mentioned, the clean-up tool 318 may be used to maintain consistency within the text of the chain in an embodiment. In other embodiments the clean-up tool 318 may be further configured to extract and remove all prompts, retain the initial prompt in order to create a cohesive response, or allow the user to remove blocks deemed unacceptable by the user by block checking.

While not illustrated in FIG. 3, the user may wish to use the system for long-form or shortform content generation. The user may decide to use the system to create long-form content such as a script, wherein there may be many pages a block of dialogue. The user may drag blocks from previous PRCs wherein there are story aspects the user wishes to incorporate such as a storyline involving a corporate takeover. The user may also import scripts to differentiate the PRC that is being assembled. In said embodiment, the user may then go through the blocks to highlight and dial up or dial down aspects of the PRC to align with their goals. Eventually, the user may wish to clean up the PRC to make their script cohesive and export it to another location such as, but not limited to, a language processor or their user device.

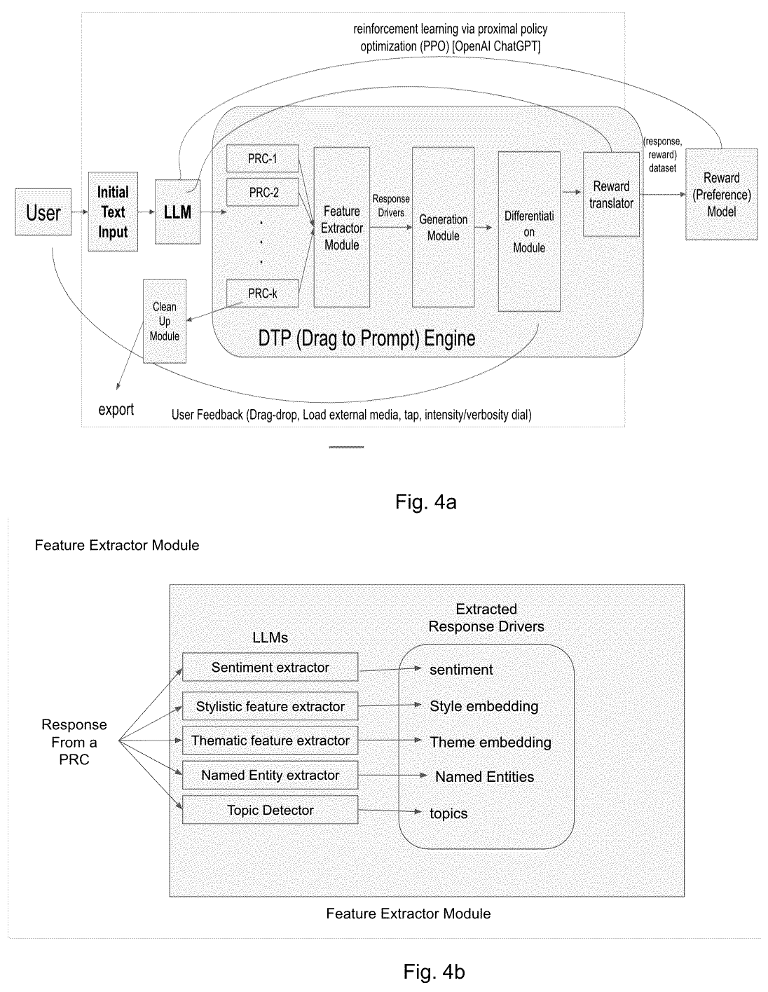

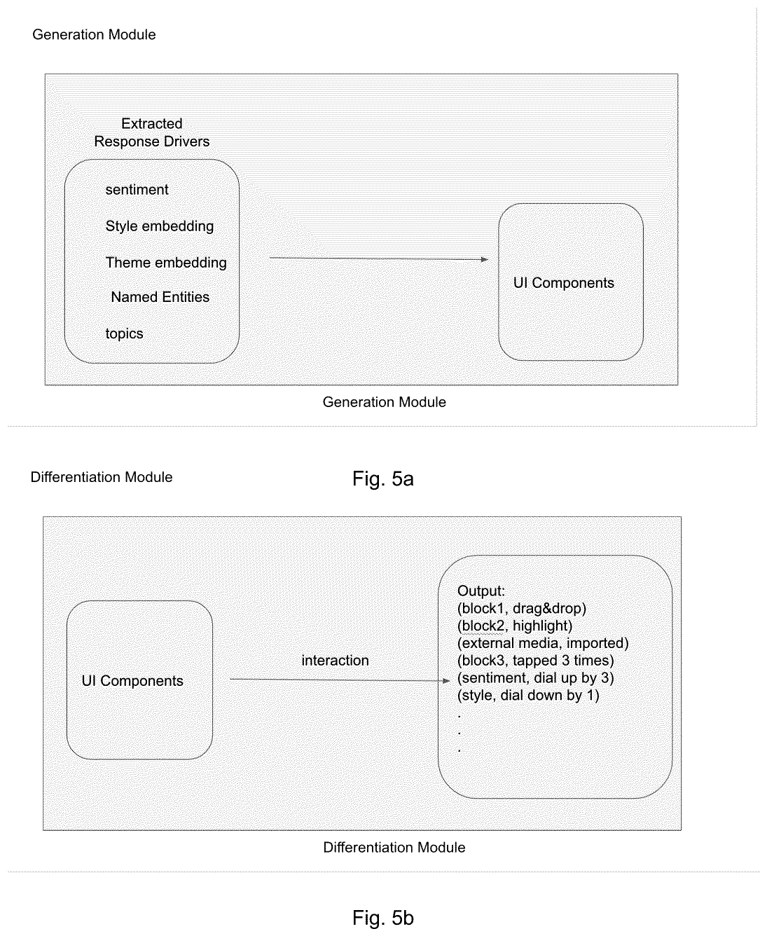

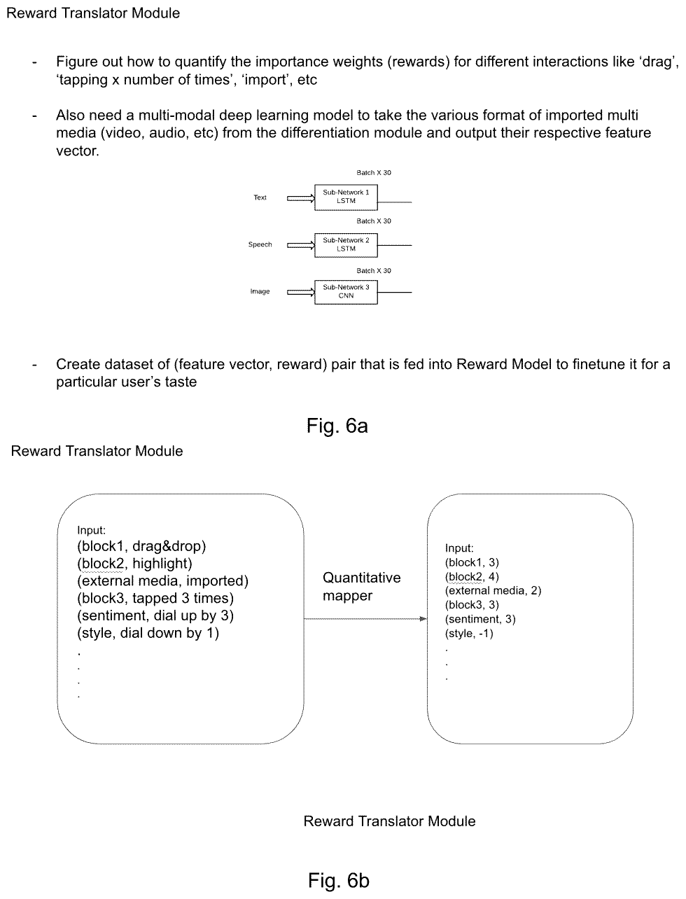

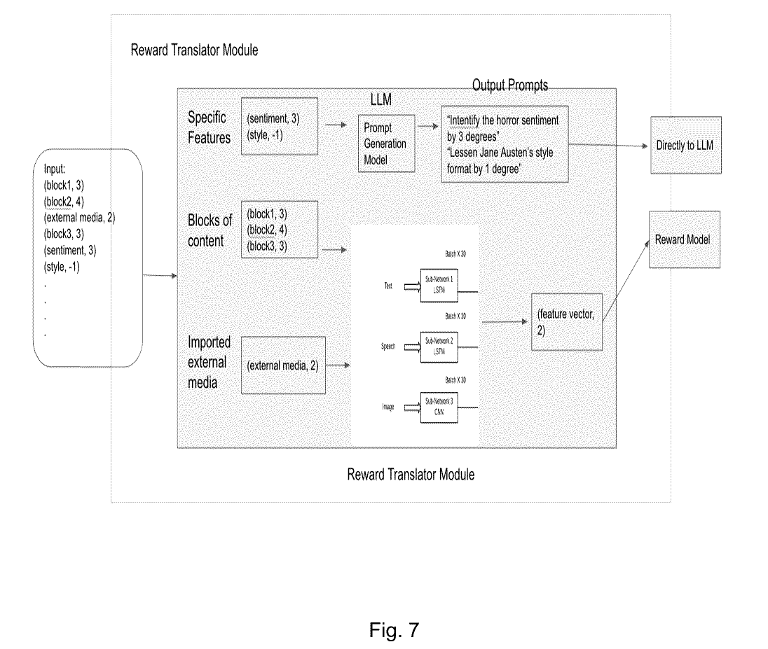

Referring to FIGS. 4-7, the present invention includes an innovative reinforcement learning via proximal policy optimization, feature extractor module, generator module, differentiation module, and reward translator module designed to enhance the training of the large language model (LLM). This module capitalizes on human feedback and inputs from the differentiation module, converting them into a format suitable for the reward model's training protocol. Consequently, this enhances the LLM's capacity for generating improved responses in subsequent iterations. Deep Learning algorithms underpin both the extraction module and the reward translator module to ensure efficient processing of complex data structures. Conversely, the generation and differentiation modules interface with the UI components, orchestrating the input/output flow essential for interactive user engagement, even though their detailed workings fall outside my domain expertise.

### Long-Form Content Generation:

In a long-form example such as a script, the user provides an initial prompt that serves as the starting point for the AI to generate the first response. This prompt can be a text-based instruction or a guideline for the movie script. The AI generates the first response using a Large Language Model. The AI creates a prompt-response chain, where each chain consists of a series of prompt and responses continuing the script. The prompts and responses are graphically represented as blocks, allowing for a visual representation of the script. Each block can be moved and manipulated using the drag-to-prompt method. The user can drag blocks representing prompts and/or responses from other chains or other chains or import files to generate subsequent prompts between blocks or replace existing blocks. This enables the user to explore different narrative directions and variations within the script.

To differentiate the prompt-response chain, the user can, after introducing blocks, user various tools to allow for changes in the stylistic and thematic elements of the script. The import from the second chain and the insertion point in the first chain contribute to this differentiation. One such tool is a dial for heightening or diminishing aspects: The user can use a dial tool to adjust certain aspects of the script, such as romance, action, or drama. Turning the dial can increase or decrease the intensity of these elements in the generated script. This tool provides a way to fine-tune the script's emotional tone or genre. The user can also tap on specific blocks to emphasize their content, wherein the number of taps corresponds to the desired level of emphasis. This action signals to the AI that the user wants more of that particular element in the script. It allows the user to highlight and amplify specific storylines, characters, or themes.

A clean-up tool is available to ensure script cohesiveness. This tool removes extra prompts that may have been generated during the creative process but are not essential to the final script. It helps refine and streamline the script's structure and narrative flow. The user can iterate through the process, continuously dragging, replacing, and differentiating prompts and responses, adjusting the dial, and double tapping blocks to fine-tune the script according to their creative vision. The clean-up tool can be used periodically to remove any unnecessary prompts and maintain script coherence.

### Short-Form Content Generation:

Similarly, in an embodiment, the user may decide to use the system for short-form content generation such as a travel itinerary. If a user is not pleased with the first response from a generative AI, they may highlight and dial up or down aspects of their prompt. Perhaps they had taken previous trips that were far more museum based than the first response and wish to have more of that in their itinerary. A user may drag blocks from previously made PRC chains involving itineraries to influence the active PRC assembly's response or import images regarding locations they wish to visit to alter the itinerary. The user may find that a restaurant has repeated itself and therefore may use the clean-up module to remove the repeat and drag over a replacement from another PRC instead of prompting again and regenerating.

In a short-form example such as an itinerary a drag-to-prompt function may not be necessary. The user interface may be designed to receive non-text-based commands and instructions through a variety of tools, including a dial function to highlight or diminish required elements of the itinerary after an initial user prompt has been provided. The user, in its initial prompt may include themes such as, but not limited to, adventure, relaxation, cultural exploration, foodie journey, family fun. The user may also include destination requests as well as the duration of time for the itinerary and budget. The user can use the dial function to highlight or diminish certain elements of the itinerary. This step allows the user to indicate preferences or priorities for specific aspects of the trip. Example elements to highlight or diminish may include: adventure activities, sightseeing landmarks, local cuisine experiences, shopping opportunities, or relaxation spots.

Based on the provided inputs, the AI model generates an itinerary that aligns with the user's preferences and requirements. The generated itinerary includes a sequence of activities, destinations, and relevant information for each day or time period specified. The itinerary can include: activities or attractions to visit, recommended restaurants or local food experiences, accommodation suggestions, transportation information, optional excursions or side trips, and estimated time required for each activity. The user can review the generated itinerary through the user interface and provide feedback or make adjustments as necessary. This feedback could be in the form of adjusting the dial settings, selecting specific elements, or requesting alternative options. Once the user is satisfied with the itinerary, the final version is generated and presented through the user interface. The itinerary can be provided in a printable or downloadable format for easy reference during the trip.

### Multi-Modal Input:

In an embodiment, multi-modal input may be used in the graphical prompting and chaining system. Various input modes, such as voice commands, touch gestures, and other input methods, in addition to the existing graphical controls may be used. This enables users to interact with the system using their preferred input modality, making it more versatile and accessible. By incorporating voice recognition technology, users can provide prompts or navigate through the system using natural language voice commands. The system can process and interpret spoken prompts, extract relevant features, and generate appropriate responses based on the extracted information. Gesture-based controls may be expanded to include touch gestures on touch-enabled devices. Users can interact with the graphical elements through touch-based gestures such as tapping, swiping, pinching, or long-pressing. These touch gestures can be mapped to specific actions, such as assigning values, dragging elements, or performing other prompt generation and chaining commands. Another input modality that can be incorporated is handwriting recognition. Users can write prompts or annotations using a stylus or finger input, and the system can convert the handwritten input into text for analysis and response generation. This allows for more natural and personalized interaction, particularly for users who prefer handwriting over typing. While graphical and touch-based interactions are emphasized, it is essential to ensure compatibility with traditional input devices like keyboards and mice. Users can continue to use these input devices to interact with the system, entering prompts, navigating through options, and manipulating graphical elements. The system can employ adaptive input recognition techniques to understand user preferences and adapt to their input patterns. Machine learning algorithms can be employed to analyze and learn from user input history, improving recognition accuracy and personalizing the interaction experience over time. Smooth and seamless switching between different input modalities can be included. Users should have the flexibility to switch between voice commands, touch gestures, and other input methods effortlessly, allowing for a fluid and uninterrupted interaction. By incorporating multi-modal input support, the capabilities of the graphical prompting and chaining system are expanded, providing users with more options to interact and engage with the system using their preferred input modality.

### A.R. Integration:

In an embodiment, the integration of augmented reality (AR) technology can enhance the graphical prompting and chaining experience. This integration introduces a new dimension to the user interface, enabling users to interact with graphical elements in their real-world environment. With AR, users can visualize and interact with the graphical elements overlaid onto their surroundings. This could involve placing the graphical prompts, chaining blocks, and other elements as virtual objects in the user's physical space. Users can perceive and manipulate these elements in a more intuitive and immersive manner. Building upon the gesture-based controls mentioned earlier, AR can provide additional gesture recognition capabilities. Users can employ hand gestures or motions to interact with the graphical elements in the augmented reality space. For example, users could use hand movements to drag, resize, or rotate the graphical elements, thereby controlling the prompt generation and chaining process. AR can leverage the real-world context to generate more contextual prompts and responses. For instance, if the user is in a specific location or pointing the device's camera towards a particular object, the system can generate prompts or responses related to that context. This enhances the relevance and personalization of the interactions. AR can also facilitate collaborative prompt generation and chaining experiences. Users can share the augmented reality space, allowing multiple participants to contribute, manipulate, and organize graphical elements simultaneously. This opens up possibilities for teamwork, brainstorming, and interactive learning scenarios. Additionally, AR can enable interactive data visualization by overlaying charts, graphs, or other visual representations onto the real-world environment. Users can explore and interact with data-driven prompts and responses in a more engaging and immersive manner, aiding comprehension and analysis. Furthermore, AR can provide visual guidance and assistance in the prompt generation and chaining process. For example, the system can project step-by-step instructions or tutorial elements directly onto the user's physical environment, assisting them in effectively utilizing the graphical controls and maximizing the system's capabilities. By integrating augmented reality technology into the graphical prompting and chaining system, user experience is enhanced, interactivity is increased, and a more intuitive and engaging environment for prompt generation, chaining, and response visualization is provided.

### Predictive Prompting:

An embodiment may include a generative AI that allows for intelligent prompt suggestions in the graphical prompting and chaining system that analyzes user input and provides contextually relevant suggestions for the next prompt. The system can leverage natural language processing and machine learning techniques to understand the current conversation context and generate prompt recommendations tailored to the ongoing discussion. By incorporating machine learning algorithms, the system can learn from user interactions, historical data, and external knowledge sources to generate intelligent and context-aware prompt suggestions. The models can be trained on a vast corpus of prompts and responses, enabling the system to suggest relevant and meaningful prompts based on the input context and desired outcomes. The intelligent prompt suggestion feature can take into account individual user preferences and behaviors. Through user profiling and adaptive learning, the system can understand each user's unique style, topic interests, and prompt generation patterns, tailoring the suggested prompts to their specific needs and preferences. The system can also provide real-time prompt suggestions as the user enters their initial prompt or during the conversation. As the user types or speaks, the system can continuously analyze the input and generate prompt recommendations that align with the evolving context, ensuring a dynamic and engaging prompt generation experience. The prompt suggestion feature can assist users in exploring different topics or angles by recommending prompts that cover a range of related concepts or perspectives. This can encourage creativity, ideation, and help users uncover new ideas or insights through the suggested prompts. The system can evaluate the quality and relevance of generated prompts to ensure that only high-quality suggestions are provided to the user. Machine learning models or rule-based techniques can be employed to assess the prompt's appropriateness, coherence, and usefulness in generating meaningful responses. The intelligent prompt suggestion feature can incorporate user feedback mechanisms to refine and improve the prompt recommendation process over time. Users can provide feedback on the suggested prompts, indicating their relevance or usefulness, which can be used to adapt and enhance the prompt generation models. To increase user trust and transparency, the system can provide explanations for the prompt suggestions, highlighting the reasons behind each recommendation. This allows users to understand the rationale and context behind the prompt suggestions, fostering a collaborative and interactive prompt generation experience. By integrating intelligent prompt suggestions, the user experience is enhanced by providing contextually relevant and personalized prompt recommendations, promoting creative thinking, and facilitating effective prompt generation in the graphical prompting and chaining system.

### Adaptive Prompting/Contextualized Prompting:

In an embodiment there may be context-aware prompt generation capabilities within the graphical prompting and chaining system. The system can consider the ongoing conversation, user history, or external factors to generate prompts that are more relevant and meaningful in the given context. The system can analyze the conversation history to understand the previous prompts, responses, and the flow of the conversation. By considering the context and content of past interactions, the system can generate prompts that align with the current discussion, building upon the existing conversation and maintaining coherence. The system can also incorporate user preferences and profiles to personalize the prompt generation process. Users can provide explicit indications of their topic interests, preferred prompt styles, or specific prompt generation guidelines. The system can adapt its prompt suggestions to align with individual user preferences. Additionally, the system can leverage environmental context cues to generate contextually relevant prompts. This can include factors such as the user's location, time of day, weather conditions, or other relevant contextual information. By incorporating such information, the system can generate prompts that are timely and tailored to the user's immediate surroundings. The system can employ natural language processing techniques to analyze the ongoing conversation and extract key topics or concepts. By identifying the dominant themes or subjects, the system can generate prompts that further explore or delve deeper into those topics, enriching the conversation and driving meaningful interactions. The context-aware prompt generation can be enhanced by integrating external data sources. The system can access news feeds, social media trends, or other relevant data to generate prompts that align with current events or trending topics. This keeps the conversation fresh and connected to real-world contexts. The system can employ adaptive machine learning models to continuously improve the prompt generation process. These models can learn from user interactions, feedback, or other sources of data to refine the prompt generation algorithms and generate prompts that align with user expectations and preferences. By analyzing user prompts and responses, the system can recognize user intents and generate prompts that align with specific goals or objectives. This helps steer the conversation towards desired outcomes and allows the system to provide more focused and relevant prompts. By incorporating context-aware prompt generation, the relevance, personalization, and engagement of the graphical prompting and chaining system is enhanced, providing users with prompts that are tailored to the ongoing conversation and their individual preferences.

### Collaborative Prompting:

In an embodiment, a generative AI can include collaborative capabilities within the graphical prompting and chaining system, allowing multiple users to contribute and collaborate on the prompt generation and chaining process. Users can work together in real-time or asynchronously, enabling teamwork, brainstorming sessions, or educational activities. The system can provide a shared virtual space where users can view and interact with the same graphical elements and prompt blocks. Each user's contributions can be displayed in real-time, allowing for a synchronized view of the ongoing prompt generation and chaining process. Users can collaborate simultaneously, seeing each other's actions and changes in the prompt chain. They can observe the prompts and responses generated by others, providing feedback, suggestions, or building upon existing prompts to create a coherent and meaningful conversation. The system can incorporate user roles and permissions to manage the collaborative environment. Administrators or prompt leaders may have additional privileges, such as the ability to manage or approve prompts, control access to specific features, or invite others to join the collaboration session. When a user modifies a prompt or adds a new prompt block, the changes can be instantly reflected for all collaborators. This ensures that all participants have an up-to-date view of the prompt chain, facilitating seamless collaboration and preventing conflicts or inconsistencies. In addition to prompt collaboration, users can collaboratively generate responses to prompts. They can collectively discuss and refine the generated responses, leveraging the collective intelligence and creativity of the group to produce high-quality and diverse responses. Collaborators can provide comments, annotations, or feedback on specific prompts or response blocks within the chain. This allows for discussions, clarification, or suggestions related to individual elements, promoting effective collaboration and knowledge sharing. The system can maintain a versioning mechanism to track the evolution of the prompt chain and facilitate rollbacks if needed. This ensures that collaborators can access and review previous iterations, trace the history of changes, and revert to earlier states if necessary. The system can support asynchronous collaboration, allowing users to contribute to the prompt chain at their convenience. Users can leave comments, suggestions, or prompts, and other collaborators can respond or build upon them when they join the collaboration session later. By introducing collaborative prompting and chaining capabilities, the system aims to foster teamwork, idea generation, and knowledge sharing within the graphical prompting and chaining system, promoting a dynamic and collaborative environment for users to collectively create meaningful conversations.

### Graphical Element (Icon) Library or Prompt-Bar:

In an embodiment, the AI prompting system may include an expanded library of graphical elements that users can utilize in the prompting and chaining process. This includes additional shapes, icons, symbols, or visual representations that users can choose from to represent prompts, responses, relationships, or other elements within the system. The library includes a broad array of graphical elements, ranging from basic shapes to intricate icons and symbols. Users can choose from various shapes, such as circles, squares, arrows, speech bubbles, connectors, and more, to represent different components within the system. Each graphical element in the library may be customizable in terms of size, color, transparency, and orientation. This flexibility allows users to tailor the visual elements to their specific preferences and requirements. Users can utilize the graphical elements to visually represent relationships between prompts and responses. For instance, they may use connecting lines or arrows to demonstrate logical connections, cause-and-effect relationships, or other correlations between different elements in the AI interface. The introduction of an Expanded Graphical Element Library offers a more interactive experience for users. By providing an array of visual representations, users can engage in creative and meaningful interactions, facilitating a more intuitive and engaging communication process with the AI system. The library is designed to be expandable, allowing for future additions of new graphical elements. This ensures that the AI interface remains up-to-date with the latest visual representation trends and user preferences. The Expanded Graphical Element Library provides users with a comprehensive range of graphical elements to enhance the visual prompting and chaining process. The combination of graphical prompting, chaining capabilities, and an extensive library of visual elements creates a powerful AI system suitable for diverse applications and user preferences. The icons or graphical elements or actionable visuals may appear as a pop-up, or as a fixed bar, or menu, or window. It may appear natively with the prompt bar and not be based on the initial prompt. In other embodiments, it may appear dynamically, in response to an identified feature of the initial prompt.

### Graphical Elements (Icon) Bar or Pop-Up or Scroll:

In an embodiment the system may also include enhanced visualization tools to assist users in understanding and manipulating the prompt and response chains effectively. The enhanced visualization tools can introduce interactive features to engage users further. For example, users may zoom in or out, pan across the graphical interface, or interact with elements to reveal additional information or hidden details. This enhances the exploration and understanding of the prompt chain. The system may allow users to customize the appearance and styling of the graphical elements. Users can modify colors, fonts, sizes, or other visual attributes of the elements to suit their preferences or to convey specific meanings or associations within the prompt chain. The graphical elements can incorporate contextual visual cues to provide additional information or context. For example, color coding can be used to signify different types of prompts or responses, line thickness can indicate the strength of relationships, or icons can represent specific categories or concepts. These visual cues aid comprehension and organization within the prompt chain. By introducing enhanced visualization tools, users are provided with a visually rich and interactive environment for exploring, organizing, and presenting prompt chains effectively within the graphical prompting and chaining system. The fixed or pop-up graphical elements as a single, spontaneous element or as part of a group of elements in the form of a bar may appear natively pre-prompt or may be generated in response to the initial prompt (feature or key driver extracted for encoding the graphical elements or actionable visuals.

### Annotate Blocks:

In another embodiment, the system further includes an annotation tool to enable users to keep track of general information in prompts and responses, enhancing the user experience and providing valuable insights into the AI-generated content. The system includes a user-friendly interface that allows users to access, create, view, edit, and delete annotations. The interface may include visual elements, text fields, and intuitive controls to facilitate seamless annotation management. Users can assign metadata tags to prompts and responses, allowing for easy categorization and organization. Tags could represent various aspects such as topic, sentiment, context, or any other relevant information. The annotation tool enables users to add free-form notes and comments to specific prompts or responses. This feature allows users to capture additional insights, feedback, or context that might be relevant in future interactions. The annotation tools may also include a feature to allow the AI to provide annotations of its own automatically. The system facilitates linking annotations to related prompts or responses, creating a coherent chain of information. Linked annotations aid in tracing the development of ideas or themes across multiple interactions. An advanced search and filtering system may be included to allow users to quickly locate specific annotations based on keywords, tags, or time of creation. This enhances the efficiency of managing and accessing annotated content. Users may have the ability to export annotated content in various formats, such as PDF or CSV, for archival or sharing purposes. This fosters collaboration and knowledge-sharing among users. The incorporation of the annotation tool in the AI interface further enhances the system's versatility and usefulness by providing users with a powerful tool to organize, analyze, and make the most of the generated content.

### Social Media/Sharing/Publishing:

In an embodiment the system further may include a Capturing Tool, enabling users to share the generated chains, prompts, or responses to social media applications, enhancing user engagement and promoting collaboration. The Capturing Tool provides users with the ability to export and share graphical chains, prompts, and responses to popular social media platforms. Users can seamlessly publish their creative and interesting interactions, either as images, videos, or interactive content, to platforms such as Twitter, Facebook, Instagram, LinkedIn, and others. Users have the flexibility to customize the content they wish to share, including selecting specific chains, prompts, or responses to export. The tool may offer options to include annotations, comments, or tags to provide context and insights when shared on social media. By sharing chains made by the AI system to social media applications, users can promote the AI interface, their own creative contributions, and foster collaboration with other users interested in similar topics or applications. The Capturing Tool includes privacy and security features to ensure that users have control over the content they share. Users can choose to share publicly or restrict access to selected audiences, as per their preferences. The tool may include built-in analytics to track user engagement and interactions with the shared content on social media. This data can offer valuable insights into the effectiveness and impact of the AI interface and user-generated chains. The Capturing Tool enables users to share their creative chains, prompts, and responses generated by the AI interface to various social media platforms. This feature not only enhances user engagement but also fosters collaboration and promotion of the AI system across a broader audience.

### Rendering Actionable Blocks

The “Rendering Files into Actionable Blocks” feature in the system enables users to seamlessly integrate files and copied text into the prompt-response chain (PRC) open track and assembly for content creation and chaining. This feature empowers users to leverage external resources and existing content in a structured and organized manner within the generative AI system. Users can upload various file formats, such as documents, presentations, or spreadsheets, directly into the system. Alternatively, they can copy and paste text from external sources. The system then processes the uploaded files or copied text and renders them as actionable blocks. These blocks serve as individual units of content that can be easily manipulated and migrated within the PRC.

By rendering files or text into actionable blocks, users can incorporate specific sections or snippets of information into their prompt-response chain. They can selectively choose relevant content and assemble it in a cohesive manner to shape the generated output. This feature streamlines the content creation process by providing users with granular control over the inclusion and arrangement of information from external sources. The rendered blocks act as building blocks within the PRC open track, allowing users to flexibly integrate and structure content according to their needs. Users can strategically position the blocks, reorder them, or interconnect them with other prompts and responses to create a coherent narrative or desired content trajectory. This feature enhances the versatility and efficiency of content creation by enabling users to leverage existing files and text within the generative AI system. It eliminates the need for manual transcription or reformatting, saving time and effort. By seamlessly incorporating external resources into the prompt-response chain, users can harness the full potential of their existing content while benefiting from the generative capabilities of the system.

Non-Text Based Content Creation (Image, Video, and/or Audio-Based Content)

The interactive tools and features provided by Graphi-Prompt can enable intuitive prompting to create non-text-based content as well, such as image, video, and audio content creation. For image content creation, users can use the intuitive interface to arrange and manipulate graphical elements, shapes, and images. They can drag and drop visual components, use graphical dials to adjust image parameters like color, size, or position, and tap specific blocks to add value or information related to the visual content. Similarly, for video content creation, the intuitive prompting interface can allow users to organize video clips, scenes, and transitions in a visual and dynamic manner. They can tap certain blocks to add prompts or information relevant to the video segments and use graphical dials to adjust video parameters like speed, opacity, or visual effects.

The collaborative prompting feature remains applicable to non-text-based content as well. Teams working on image or video projects can collaboratively prompt and co-chain their ideas, enabling seamless cooperation and enhancing the overall creative process. All other text-based content tools and features previously articulated also apply to image and video-based content creation.

In yet other embodiments, a user may import graphi-prompt account user profiles (masked, scrambled, encrypted, or naked) of other users in order to better inform a response intended to that other user. The system not only taking into account the user history, profile of the sender or creator, but also the target recipient.

The strength of the intuitive prompting interface lies in its adaptability across different media formats, including non-text-based content. By providing a visual and interactive approach to content creation, Graphi-Prompt empowers users to create compelling and engaging content in various domains beyond text-based interactions—for intuitively prompted A.I. generated content (language, image, video, and/or audio-based A.I. models).

Embodiments are described at least in part herein with reference to flowchart illustrations and/or block diagrams of methods, systems, and computer program products and data structures according to embodiments of the disclosure. It will be understood that each block of the illustrations, and combinations of blocks, can be implemented by computer program instructions. These computer program instructions may be provided to a processor of a general-purpose computer, special purpose computer, or other programmable data processing apparatus to produce a machine such that the instructions, which execute via the processor of the computer or other programmable data processing apparatus, create means for implementing the functions/acts specified in the block or blocks.

These computer program instructions may also be stored in a computer-readable memory that can direct a computer or other programmable data processing apparatus to function in a particular manner such that the instructions stored in the computer-readable memory produce an article of manufacture including instruction means which implement the function/act specified in the block or blocks.

The computer program instructions may also be loaded onto a computer or other programmable data processing apparatus to cause a series of operational steps to be performed on the computer or other programmable apparatus, to produce a computer implemented

process such that, the instructions which execute on the computer or other programmable apparatus provide steps for implementing the functions/acts specified in the block or blocks.

In general, the word “module” as used herein, refers to logic embodied in hardware or firmware, or to a collection of software instructions, written in a programming language, such as, Java, C, etc. One or more software instructions in the unit may be embedded in firmware. The modules described herein may be implemented as either software and/or hardware modules and may be stored in any type of non-transitory computer-readable medium or other non-transitory storage elements. Some non-limiting examples of non-transitory computer-readable media include CDs, DVDs, BLU-RAY, flash memory, mobile device, remote device, and hard disk drives.

1. A drag-to-prompt method, said method comprising the steps of:
a. generating, a first response by a Large Language Model based on an initial user prompt, comprising of a text-based instruction, in a first and at least a second independent prompt-response chain. Wherein an initial user prompt and first response is different in each chain and the prompts and responses are graphically represented as blocks;
b. dragging at least one of a prompt and/or response block to generate subsequent prompt between blocks and/or replace a block; and
c. differentiating the first prompt response chain by introducing and/or replacing at least one of a prompt or response from within the chain or from at least the second chain to regenerate text of the response, wherein differentiating is altering a stylistic and/or thematic element of the first chain based on the import from the second chain and insertion point in the first chain.

2. The method of claim 1, wherein the dragging occurs by a drag and drop in at least one form of a mouse cursor, vocalized request, hand gesture, or touch control.

3. The method of claim 1, wherein the dragging further comprises the option to regenerate the entire chain.

4. The method of claim 1, wherein the dragging further comprises the option to regenerate pre-selected blocks.

5. The method of claim 1, wherein the dragging further comprises the option to regenerate the inserted block.

6. The method of claim 1, wherein the dragging further comprises the option to insert imported files.

7. The method of claim 6, wherein the imported files may be at least one of: technology, media, audio, or video files.

8. The method of claim 1, further comprising the step of a pinpoint drop, wherein different prompt commands are issued depending on the location of a dropped block.

9. The method of claim 1, further comprising the step of tapping for value, wherein the number of taps on a block increases its value and impact on the prompt-response chain.

10. The method of claim 1 wherein, the user controls the intensity of the differentiation caused by the imported block.

11. The method of claim 1, wherein user directs modification of the subsequent chain and/or modifies the chain prior to the insertion point of the prompt and/or response.

12. The method of claim 1, wherein an inserted block differentiates pre-selected responses of the first chain.

13. The method of claim 1, further comprising an option of a chain clean up wherein every prompt is removed.

14. The method of claim 13, further comprising of an option to keep the initial user prompt.

15. The method of claim 13, further comprising of an option to maintain consistency within the text of the chain.

16. The method of claim 13, further comprising the step of block checking, wherein a user may remove unnecessary response blocks.

17. The method of claim 1, further comprising the option to save and/or share the chain.

18. A method for graphically prompting in an interface, comprising:
a. receiving an initial text-based prompt from a user in a large language model;
b. extracting features from the text deemed response critical using a natural language processing component configured to analyze the initial text-based prompt and identify key features for response generation;
c. encoding the extracted features as graphical elements using a graphic rendering module configured to convert the extracted features into visual representations mapped to graphical elements; and
d. enabling the user to direct the second prompt by engaging the graphical element with gesture-based controls detected and interpreted by a gesture recognition module.

19. A method for graphically prompting, said system comprising:
a. receiving an initial text-based prompt from a user in a large language model;
b. extracting features from the text deemed response critical, wherein the extraction comprises a natural language processing component configured to analyze the initial text-based prompt and identify key features for response generation; and
c. encoding the extracted features as graphical elements configured for enabling a user to direct the second prompt by engaging the graphical element with gesture-based controls, wherein the means for encoding comprises a graphic rendering module configured to convert the extracted features into visual representations mapped to graphical elements.
